(19) United States
(12) Patent Application Publication
(10) Pub. No.: US 2025/0178193 A1
(43) Pub. Date: Jun. 5, 2025

(54) METHOD FOR CONTROLLING AN INVENTORY ROBOT

(71) Applicant: Y.E. Hub Armenia LLC, Yerevan (AM)

(72) Inventors: Ivan KALINOV, Kaliningrad (RU); Mikhail KURENKOV, Sarov (RU); Aleksandr PETROVSKII, Saint Petersburg (RU)

(21) Appl. No.: 18/962,132

(22) Filed: Nov. 27, 2024

(30) Foreign Application Priority Data
Dec. 1, 2023 (RU) 2023131571

(51) Int. Cl. B25J 9/16; B25J 5/00; B25J 13/08

(52) U.S. Cl. CPC B25J 9/1651; B25J 5/007; B25J 9/161; B25J 13/088

(57) ABSTRACT

A robotic vehicle and a method for controlling a robotic vehicle are disclosed. The robotic vehicle including a ground platform movable on a ground surface, a longitudinal body extending from the ground platform, a sensor located along the longitudinal body, and a processor communicatively coupled to the sensor. The method includes receiving a signal generated by the sensor indicative of oscillating movement of the longitudinal body during operation of the robotic vehicle on the ground surface and receiving a reference signal representative of a normal operating state of the robotic vehicle. In response to the signal being outside a threshold interval from the reference signal: modifying a current speed of the robotic vehicle so as to reduce oscillating movement of the longitudinal body.

### CROSS-REFERENCE

The present application claims priority to Russian Patent Application No. 2023131571, entitled “Method for Controlling an Inventory Robot”, filed Dec. 1, 2023, the entirety of which is incorporated herein by reference.

### FIELD

The present technology relates generally to inventory robots for transporting inventory of various items from one location to another within a warehouse.

### BACKGROUND

Inventory robots are widely used for transporting various items stored in a warehouse, including, for example, finished products, units of raw materials, and the like from one location to another location within a warehouse. More specifically, such robots typically include: (i) a movable platform enabling a given inventory robot to move along and between aisles of the warehouse; (ii) a frame having a mast extending from the movable platform; and (iii) a container or a tote slidably attached to the mast and configured to transport goods from one location to another within the warehouse, for example when moving goods from storage to another location for processing and/or dispatching.

To reach items stored on the top shelves of the warehouse, the mast of the robot is larger compared to the movable platform, which is sized smaller to enable easy movement around the warehouse. As a result, the mast oscillates during movement of the robot. In some instances, the oscillation of the mast may reach the same frequency as the movable platform, reaching a resonance, which causes the oscillations of the mast to amplify. As the oscillations of the mast increase in amplitude and frequency, the robot begins to tilt and ultimately falls over. This poses a safety hazard for the workers within the warehouse and may damage the warehouse shelving units and/or the goods the robot is carrying.

Certain prior art approaches have been proposed to tackle the above-identified technical problem.

United States Patent Application Publication No.: 2008/223,134-A1, published on Sep. 18, 2008, assigned to Homburg Sven and Jost Gunther, and entitled “METHOD AND DEVICE FOR TESTING THE STABILITY AND/OR BENDING STRENGTH OF MASTS”, discloses a process for testing the stability or bending strength of a mast in which the test is dynamic,

United States Patent Application Publication No.: 2017/312,922-A1, published on Nov. 2, 2017, assigned to Seiko Epson Corp, and entitled “VIBRATION MEASUREMENT METHOD FOR MOVING PART, VIBRATION MEASUREMENT METHOD FOR ROBOT, AND CONTROL DEVICE”, discloses a vibration measurement method for a moving part in which vibration of a moving part is measured using a first inertial sensor.

Journal Article Entitled: “Vibration Suppression of Two-Wheel Mobile Manipulator Using Resonance-Ratio-Control-Based Null-Space Control” published on January 2011 in IEEE Transactions on Industrial Electronics 57(12):4137-4146, discloses a two wheel mobile manipulator becoming a multi-skilled robot using inverted pendulum control where the center of gravity position is controlled to achieve the balancing of the robot and vibration control of the manipulator arms is described.

United States Patent Application Publication No.: 2020/376,656-A1, published on Dec. 3, 2020, assigned to X DEV LLC, and entitled “MOBILE ROBOT MORPHOLOGY”, discloses a mobile base; a mounting column fixed to the mobile base; a seven-degree-of-freedom (7DOF) robotic arm, comprising a rotatable joint that enables rotation of the 7DOF robotic arm relative to the mounting column; and a perception housing comprising at least one sensor.

United States Patent Application Publication No.: 2021/403,024-A1, published on Dec. 30, 2021, assigned to DoorDash Inc., and entitled “HYBRID AUTONOMY SYSTEM FOR AUTONOMOUS AND AUTOMATED DELIVERY VEHICLE”, discloses a method for operating an autonomous vehicle for delivery of perishable goods.

### SUMMARY

It is an object of the present technology to ameliorate at least some of the inconveniences of the prior art.

In a broad aspect of the present technology, there is provided a method for controlling a robotic vehicle, the robotic vehicle including a ground platform movable on a ground surface, a longitudinal body extending from the ground platform, a sensor located along the longitudinal body, and a processor communicatively coupled to the sensor. The method includes receiving a signal generated by the sensor indicative of oscillating movement of the longitudinal body during operation of the robotic vehicle on the ground surface and receiving a reference signal representative of a normal operating state of the robotic vehicle. In response to the signal being outside a threshold interval from the reference signal: modifying a current speed of the robotic vehicle so as to reduce oscillating movement of the longitudinal body.

In some embodiments, modifying the current speed of the robotic vehicle comprises reducing the current speed of the robotic vehicle.

In some embodiments, the longitudinal body has a top end and a bottom end, the bottom end connected to the ground platform. The sensor is a first sensor located at the top end of the longitudinal body, the signal being a first signal indicative of oscillating movement of the top end of the longitudinal body. The robotic vehicle further includes a second sensor located on a portion of the longitudinal body between the top end and the bottom end, the second sensor being communicatively coupled to the processor. The method includes monitoring a second signal provided by the second sensor indicative of oscillating movement of the portion of the longitudinal body. In response to the second signal being outside a second threshold interval from a second reference signal: modifying the current speed of the robotic vehicle so as to reduce oscillating movement of the portion of the longitudinal body.

In some embodiments, the method further includes: comparing the first signal of the first sensor and the second signal of the second sensor, determining whether the longitudinal body is experiencing a higher-risk oscillation type or a lower-risk oscillation type. The higher-risk oscillation type occurs when the first signal and the second signal are in phase and the lower-risk oscillation type occurs when the first signal and the second signal are out of phase.

In some embodiments, when the higher-risk oscillation type is determined, the threshold interval is a first higher-risk threshold interval, and the second threshold interval is a second higher-risk threshold interval and when the lower-risk oscillation type is determined, the threshold interval is a first lower-risk threshold interval, and the second threshold interval is a second lower-risk threshold interval. The first lower-risk threshold interval is different than the first higher-risk threshold interval and the second lower-risk threshold interval is different than the second higher-risk threshold interval.

In some embodiments, the robotic vehicle further includes a third sensor positioned on a bottom portion, the bottom portion located between the second sensor and the bottom end, and the third sensor being communicatively coupled to the processor. The method further includes: monitoring a third signal provided by the third sensor indicative of oscillating movement of the bottom portion of the longitudinal body. In response to the third signal being outside a threshold interval from a third reference signal: modifying the current speed of the robotic vehicle so as to reduce oscillating movement of the bottom portion of the longitudinal body.

In some embodiments, receiving the signal generated by the sensor is indicative of at least one of: a speed, an angular velocity, a linear velocity, a displacement, an angular acceleration, and a linear acceleration of the longitudinal body.

In some embodiments, further comprising redistributing a position of a container along a length of the longitudinal body and sending an alert to an operator.

In another broad aspect of the present technology, there is provided a robotic vehicle for delivering containers within a warehouse. The robotic vehicle includes a ground platform moveable along a ground surface, a longitudinal body extending from the ground platform for receiving and delivering a container, a sensor positioned on the longitudinal body for generating a signal indicative of oscillating movement of the longitudinal body, and at least one processor communicatively connected to the sensor. The at least one processor being configured to: receive the signal generated by the sensor, compare the signal with a reference signal, and modify a current speed of the robotic vehicle if the signal is outside a threshold interval from the reference signal so as to reduce oscillating movement of the longitudinal body.

In some embodiments, the longitudinal body comprises a top end and a bottom end, the bottom end being connected to the ground platform. The sensor is a first sensor for generating a first signal positioned at the top end of the longitudinal body such that the first signal generated by the first sensor is indicative of oscillating movement of the top end of the longitudinal body.

In some embodiments, the robotic vehicle further includes a second sensor positioned at a portion of the longitudinal body for generating a second signal indicative of oscillating movement at the portion of the longitudinal body, the portion being between the top end and the bottom end of the longitudinal body. The at least one processor being communicatively connected to the second sensor, the at least one processor being configured to: receive the second signal generated by the second sensor, compare the second signal with a second reference signal, and modify the current speed of the robotic vehicle if the second signal is outside a second threshold interval from the second reference signal so as to reduce oscillating movement of the portion.

In some embodiments, the first sensor and the second sensor are evenly spaced along the longitudinal body.

In some embodiments, the robotic vehicle further includes a third sensor positioned at a bottom portion of the longitudinal body for generating a third signal indicative of oscillating movement at the bottom portion of the longitudinal body, the bottom portion being between the bottom end and the second sensor, and the at least one processor being communicatively connected to the third sensor. The at least one processor being configured to: receive the third signal generated by the third sensor, compare the third signal with a third reference signal, and modify the current speed of the robotic vehicle if the third signal is outside a third threshold interval from the third reference signal so as to reduce oscillating movement of the bottom portion.

In some embodiments, the first sensor, the second sensor, and the third sensor, are evenly spaced along the longitudinal body.

In some embodiments, the longitudinal body is foldable and comprises a first body pivotably connected to a second body.

In some embodiments, a length of the longitudinal body is larger than a length of the ground platform.

In another broad aspect of the present technology, there is provided a method for controlling a robotic vehicle. The robotic vehicle includes a ground platform movable on a ground surface. A longitudinal body extends from the ground platform. A sensor is located along the longitudinal body, and a processor is communicatively coupled to the sensor. The method comprises receiving a signal generated by the sensor indicative of oscillating movement of the longitudinal body during operation of the robotic vehicle on the ground surface, feeding the signal to a machine learning algorithm for determining a predicted class, where the machine learning algorithm has been trained to predict whether the signal is of a first class or a second class based on a training signal and a label, and where the label is indicative of whether the training signal is of a first class or a second class. The method comprises, in response to the predicted class: modifying a current speed of the robotic vehicle so as to reduce oscillating movement of the longitudinal body.

In the context of the present specification, “electronic device” denotes any computer hardware that is capable of running software appropriate to the relevant task at hand. In the context of the present specification, the term “electronic device” implies that a device can function as a server for other electronic devices and client devices, however it is not required to be the case with respect to the present technology. Thus, some (non-limiting) examples of electronic devices include personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices. The use of the expression “an electronic device” does not preclude multiple client devices being used in receiving/sending, carrying out or causing to be carried out any task or request, or the consequences of any task or request, or steps of any method described herein.

For purposes of this application, terms related to spatial orientation such as forwardly, rearwardly, upwardly, downwardly, left, and right, are as they would normally be understood by a user or operator of the camera device. Terms related to spatial orientation when describing or referring to components or sub-assemblies of the device, separately from the device should be understood as they would be understood when these components or sub-assemblies are mounted to the device.

Implementations of the present technology each have at least one of the above-mentioned aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a perspective view of a robotic vehicle, in accordance with certain non-limiting embodiments of the present technology;

FIG. 2 depicts a front plan view of the robotic vehicle of FIG. 1, in accordance with certain non-limiting embodiments of the present technology;

FIG. 3 depicts a side plan view of the robotic vehicle of FIG. 1, in accordance with certain non-limiting embodiments of the present technology;

FIG. 4 depicts a flow chart for controlling a robotic vehicle in response to a signal received by a processor of the robotic vehicle, in accordance with certain non-limiting embodiments of the present technology;

FIG. 5 depicts a flow chart for controlling a robotic vehicle in response to signals received by a processor of the robotic vehicle, in accordance with certain non-limiting embodiments of the present technology;

FIG. 6A depicts a graph of a first signal from a first oscillation sensor indicative of acceptable oscillations, in accordance with certain non-limiting embodiments of the present technology;

FIG. 6B depicts a graph of a first signal from a first oscillation sensor indicative of high risk oscillations, in accordance with certain non-limiting embodiments of the present technology;

FIG. 7 depicts a side plan view of the robotic vehicle with a middle portion of a mast of the robotic vehicle under oscillation, in accordance with certain non-limiting embodiments of the present technology;

FIG. 8 depicts a flow chart for controlling a robotic vehicle in response to signals received by a processor of the robotic vehicle, in accordance with certain non-limiting embodiments of the present technology;

FIG. 9 depicts a side plan view of the robotic vehicle with a middle portion of a mast of the robotic vehicle under oscillation, in accordance with certain non-limiting embodiments of the present technology;

FIG. 10 depicts a flow chart for controlling a robotic vehicle while implementing a machine learning algorithm, in accordance with certain non-limiting embodiments of the present technology; and

FIG. 11 depicts a flow chart for controlling a robotic vehicle while implementing a machine learning algorithm, in accordance with certain non-limiting embodiments of the present technology.

### DETAILED DESCRIPTION

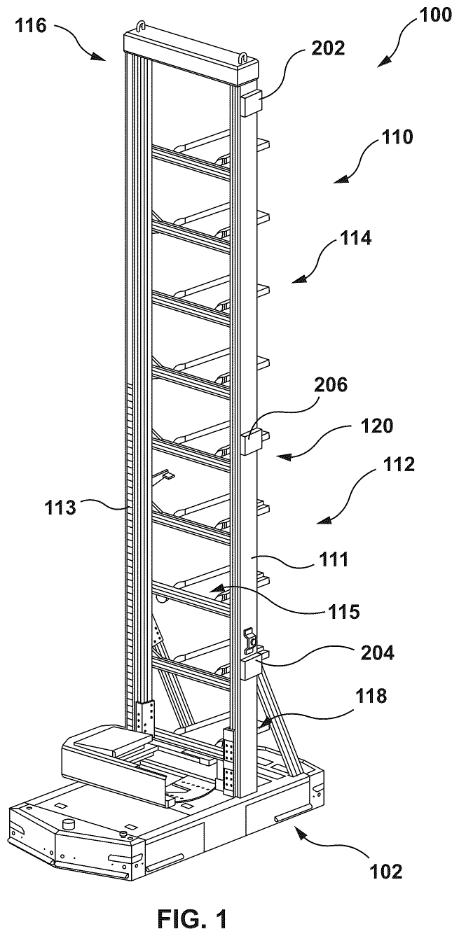

With reference to FIGS. 1 to 3, there is depicted a robotic vehicle 100. According to certain non-limiting embodiments of the present technology, the robotic vehicle 100 is an inventory robot 100 which can be used for delivering inventory of various items stored in a warehouse from one location to another, for example from a storage location to a processing or dispatching location within the warehouse. Such items can include, without limitation, food products, industrial articles, raw materials used for producing various products and articles, and the like. Broadly speaking, for storing such items, warehouse racks including multiple levels of shelves can be installed in the warehouse. The items can be stored on the shelves of the warehouse racks either individually or in containers of certain dimensions, such as pallets.

The inventory robot 100 can be configured to move along the warehouse racks (that generally form aisles in the warehouse) and move the items stored on the shelves of the warehouse racks to other locations within the warehouse. In certain non-limiting embodiments of the present technology, the inventory robot 100 may include scanning sensors to scan the items on the shelves for monitoring purposes and/or when selecting which items are to be moved. For example, the inventory robot 100 scans the items stored on the shelves and identifies the specific item which is to be moved. The inventory robot 100 retrieves the item from the shelf and transports the item to the desired location.

As depicted in FIG. 1, the inventory robot 100 comprises a moveable ground platform 102 and a selectively extendable frame 110 extending outwardly from the movable platform 102.

According to certain non-limiting embodiments of the present technology, as depicted in FIG. 1, the movable platform 102 can have a top surface (not separately numbered) extending substantially parallel to a support surface, on which the inventory robot 100 is to travel, such as a floor of the warehouse. A shape of the top surface of the movable platform 102 is not limited, and can be, in various non-limiting embodiments of the present technology, round, rectangular, square, oval, and others. Thus, as depicted in FIG. 1, in some non-limiting embodiments of the present technology, the movable platform 102 can have a form of a parallelepiped, each face of which can be a separate rectangle. A material of the movable platform 102 is not limited and can include, for example, various plastics or metals, such as galvanized or stainless steel.

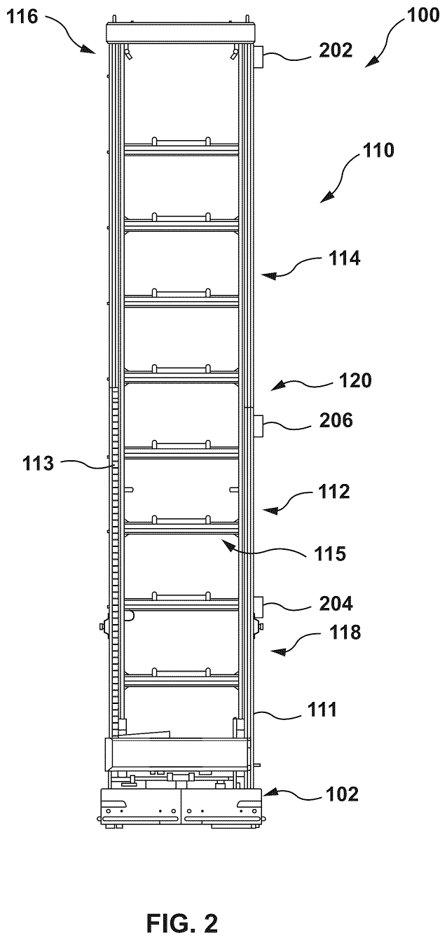

As seen in FIG. 2, the moveable platform 102 can include wheels 104 attached to a bottom surface 106 of the moveable platform 100 and configured to move across the support surface. In some non-limiting embodiments of the present technology, a given wheel 104 of the movable platform 102 can be configured to rotate only about a horizontal axis of the given wheel 104 (when the given wheel 104 is attached to the bottom surface 106 of the movable platform 102), extending through a center thereof, thereby enabling the movable platform 102 to perform a linear movement along the support surface. Accordingly, a counter-clockwise rotation of the wheels 104 enables the movable platform 102 and hence the inventory robot 100 to move forward, which for the purposes of clarity is referred to herein a movement direction 108. By contrast, a clockwise rotation of the wheels enables for a backward movement of the movable platform 102 and hence that of the inventory robot 100.

In some non-limiting embodiments of the present technology, the moveable platform 102 may have the wheels 104 dispersed along the bottom surface 108. For example, the moveable platform 102 may include at least front wheels positioned in a front portion of the bottom surface 106 and at least back wheels positioned in a back portion of the bottom surface 106. The front wheels of the moveable platform 102 can be configured to spin around a vertical axis (extending perpendicularly to the bottom surface 106 of the moveable platform 102), thereby enabling the moveable platform 102 to turn right and left while moving in a movement direction 108. In additional non-limiting embodiments of the present technology, each of the wheels 104 of movable platform can be configured to spin about their respective axes by 90 degrees, thereby enabling the movable platform 102 to move transversely to the movement direction 108. In further non-limiting embodiments of the present technology, each of the wheels 104 of the moveable platform 102 can be configured to spin freely about their respective axes, thereby enabling the moveable platform 102 to move in various directions.

It should be expressly understood that various configurations of the wheels 104 of the movable platform 102 are envisioned. For example, the wheels 104 can be implemented as caster wheels of any suitable size, such as from 1 to 10 cm in diameter, and/or for a suitable weight range of a weight to be borne on the wheels 104, including that of the movable platform 102, the selectively extendable frame 110, and additional equipment installed within the inventory robot 100, such as under 250 kg, from 250kg to 1000 kg, and from over 1000 kg, as an example. Also, the material of the wheels 104 of the movable platform 102 is not limited, and in specific non-limiting embodiments of the present technology, can include: ductile steel, phenolic nylon, and polyurethane, as an example. However, embodiments where the wheels 104 of the movable platform 102 are installed on continuous tracks are also envisioned without departing from the scope of the present technology.

To actuate the wheels 104 to cause the movement of the movable platform 102, according to non-limiting embodiments of the present technology, the inventory robot 100 can further comprise a platform actuator (not separately numbered), which can, for example, be a rotation actuator, an actuator shaft of which is coupled to the wheel axles each of the front and rear wheels so as to provide a torque thereto causing the rotation of the wheels 104 and hence the movement of the movable platform 102. For example, the actuator shaft of the platform actuator can be coupled to the wheel axles of the wheels 104 via a drivetrain of the movable platform 102, which is configured to transfer the torque from the actuator shaft to each of the wheels 104.

In certain non-limiting embodiments of the present technology, the drivetrain of the movable platform 102 can be configured to transfer the torque from the platform actuator to each of the wheels 104 independently. In other words, in these embodiments, the drivetrain of the movable platform 102 can be configured to provide thereto an all-wheel drive.

It is not limited how the rotation actuator causing the movement of the wheels 104 of the movable platform 102 can be implemented. In some non-limiting embodiments of the present technology, the rotation actuator can be implemented as an electric motor. In specific non-limiting example, the electric motor can be one of the servomotors MicroFlex e190 available from ABB Ltd of Affolternstrasse 44, 8050 Zurich, Switzerland. However, it should be noted that the electric motor can be implemented using any other suitable equipment, also including, for example brushless and stepper motors, as an example. Also, it should be noted that other types of motors can be used for implementation of the platform actuator without departing from the scope of the present technology, including, for example, pneumatic and hydraulic motors. For example, the platform actuator can be installed within the movable platform 102, in a compartment defined by surfaces thereof.

Further, for controlling operation of the platform actuator as well as that of other electrical and electronic components of the inventory robot 100, as will become apparent from the description provided hereinbelow, according to certain non-limiting embodiments of the present technology, the inventory robot 100 can further comprise a controller (not depicted).

In some non-limiting embodiments of the present technology, the controller comprises a processor. In some embodiments of the present technology, the processor may comprise one or more processors and/or one or more microcontrollers configured to execute instructions and to carry out operations associated with the operation of the inventory robot 100. In various non-limiting embodiments of the present technology, the processor may be implemented as a single-chip, multiple chips and/or other electrical components including one or more integrated circuits and printed circuit boards. The processor may optionally contain a cache memory unit for temporary local storage of instructions, data, or additional computer information. By way of example, the processor may include one or more processors or one or more controllers dedicated for certain processing tasks of the inventory robot 100 or a single multi-functional processor or controller. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage.

Further, according to some non-limiting embodiments of the present technology, the controller may include a communication module (not depicted). Such a communication module may be configured for implementing one of communication protocols (both wireless and wired) enabling the processor to be connected with other electronic devices or remote servers. Various examples of how the communication module may be implemented include, without being limited to, a Bluetooth™ communication module, a UART™ communication module, a Wi-Fi™ communication module, an LTE™ communication module, and the like.

According to the non-limiting embodiments of the present technology, communication between the controller and other electrical and electronic components of the inventory robot 100, as will become apparent from the description provided below, such as the platform actuator (not depicted) may be implemented by one or more internal and/or external buses (e.g. a PCI bus, universal serial bus, IEEE 1394 “Firewire” bus, SCSI bus, Serial-ATA bus, etc.), with which each one of these electrical and electronic components is compatible. For example, the controller can also be received in the compartment defined by the surfaces of the movable platform 102.

Thus, according to certain non-limiting embodiments of the present technology, the processor of the controller can be configured, by executing respective control instructions, to control the operation of the platform actuator, thereby controlling the movement of the movable platform 102, which includes, without limitation: (i) starting and stopping the movement of the movable platform 102; (ii) selecting the movement direction 108 of the movable platform 102, (iii) controlling the movement parameters of the movable platform 102 in the movement direction 108, such as a current speed and a current acceleration values; (iv) maneuvering the movable platform 102; and the like. In some non-limiting embodiments of the present technology, the respective control instructions can be provided to the processor, via a corresponding communication link as described above, from the remote electronic device or the server in real time, thereby enabling real time control of the movement of the inventory robot 100. However, in other non-limiting embodiments of the present technology, the respective control instructions can be pre-uploaded to the storage coupled with of the processor causing the inventory robot 100 to move in certain patterns, as an example. In these embodiments, the respective control instructions can be updated from time to time.

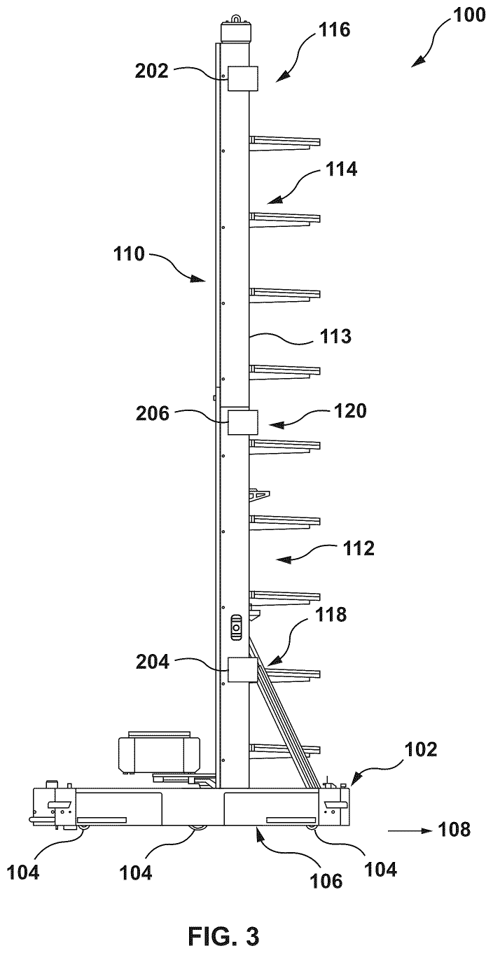

With reference to FIGS. 1 and 3, the selectively extendable frame 110 comprises at least two vertically sliding sections, that is, a first vertically sliding section 112 and a second vertically sliding section 114. A given one of the first and second vertically sliding sections 112, 114, for example, the first vertically sliding section 112, comprises a first mast 111 and a second mast 113 interconnected by a transverse connecting section 115. The first and second masts 111, 113 of the first vertically sliding section 112 are attached to the movable platform 102, whereas masts of the second vertically sliding section 114 are retained on the first and second masts 111, 113 of the first vertically sliding section 112 at a given level relative thereto, thereby defining a desired length value of the selectively extendable frame 110.

According to various non-limiting embodiments of the present technology, it is not limited how the first and second masts 111, 113 of the first vertically sliding section 112 are attached to the movable platform 102. In some non-limiting embodiments of the present technology, the first and second masts 111, 113 can be welded to the movable platform 102. In other non-limiting embodiments of the present technology, the first and second masts 111, 113 can be attached to the moveable platform 102 via a fastener such as a bolt connection.

In some non-limiting embodiments of the present technology, the first and second masts 111, 113 can be attached to the moveable platform 102 such that the first vertically sliding section 112, and hence the selectively extendable frame 110, is substantially perpendicular to the moveable platform 102. However, in other non-limiting embodiments of the present technology, the fist and second masts 111, 113 can be attached to the moveable platform 102 such that the first vertically sliding section 112 forms an angle with the moveable platform which is different from 90 degrees. In other words, in these embodiments, the selectively extendable frame 110 can either be bent forward or tilted back relative to the movable platform 102. The angle between the first vertically sliding section 112 and the movable platform 102 is not limited and, in some non-limiting embodiments of the present technology, can be selected based on a condition that a horizontal projection of a center of gravity of the selectively extendable frame 110 is within a perimeter of the movable platform 102.

In additional non-limiting embodiments of the present technology, the selectively extendable frame 110 can be additionally attached to the movable platform 102 via cables (not depicted) that are stretched taut between a top of the vertically sliding section of the selectively extendable frame 110, that is, the second vertically sliding section 114 and the movable platform 102. A certain number of the cables, such as two, for example, can be attached to each side of the second vertically sliding section 114, relative to the movement direction 108 of the inventory robot 100. In some non-limiting embodiments of the present technology, a given cable can be implemented as a braded steel wire cable, a cross-section of which is determined based on a weight of the selectively extendable frame 110, for example.

According to certain non-limiting embodiments of the present technology, the masts of each one of the first and second vertically sliding sections 112, 114, such as the first and second masts 111, 113 of the first vertically sliding section 112, are positioned transversely with respect to the movement direction 108 of the inventory robot 100. Also, in some non-limiting embodiments of the present technology, the first and second masts 111, 113 can extend substantially parallelly to each other. However, in other non-limiting embodiments of the present technology, the first and second masts 111, 113 can extend at a given angle to each other. For example, the first and second masts 111, 113 can form respective arms of the given angle.

It is not limited how each of the first and second masts 111, 113 are implemented. In various non-limiting embodiments of the present technology, a cross-section of a given mast of the first and second masts 111, 113 can be, without limitation, triangular, square, rectangular, polyhedral, or circular. In some non-limiting embodiments of the present technology, the given mast of the first and second masts 111, 113 can be hollow; in other non-limiting embodiments of the present technology, the given mast can be solid. A material of each one of the first and second masts 111, 113 is also not limited and, in various non-limiting embodiments of the present technology, can include, without limitation, a metal (such as steel or aluminium), plastic, wood, and others. A thickness of the material of the each one of the first and second masts 111, 113 is also not limited and can be selected, for example, based on a trade-off between a desired weight of the given mast and a bearing capacity thereof.

The transverse connecting section 115 can include a plurality of cross-bars disposed in between the first and second masts 111, 113 and attached thereto, such as by welding. In other non-limiting embodiments, the first and second masts 111, 113 and the plurality of cross-bars may be wholly cast. In some non-limiting embodiments of the present technology, a configuration and material of each one of the plurality of cross-bars can be the same as those of the first and second masts 111, 113. However, in other non-limiting embodiments of the present technology, the configuration and material of each one of the plurality of cross-bars can be the different from those of the first and second masts 111, 113. For example, while in some embodiments each one of the first and second masts 111, 113 can be hollow, each one of the plurality of cross-bars can be solid. In another example, while in some embodiments, the cross-section of the given mast of the first and second masts 111, 113 can be circular, a cross-section of the given cross-bar can be rectangular. In yet other example, while in some embodiments the material of the given mast of the fist and second mast 111, 113 can be steel, the material of the give cross-bar can be aluminium.

Further, in accordance with certain non-limiting embodiments of the present technology, each one of the plurality of cross-bars are distributed between evenly between the first and second masts 111, 113 of the first vertically sliding section 112, such as with a predetermined step, which can be 20, 30 or 50 cm, as an example. However, in other non-limiting embodiments of the present technology the cross-bars can be disposed only within certain portions of a space between the first and second masts 111, 113, such as at ends thereof and at a medium level, as an example.

Further, in some non-limiting embodiments of the present technology, each one of the plurality of cross-bars can be disposed in parallel to each other. In these embodiments, if the first and second masts 111, 113 are also parallel to each other, each one of the cross-bars would be perpendicular to the first and second masts 111, 113. However, in other non-limiting embodiments of the present technology, at least some of the cross-bars can be disposed at a predetermined angle to the given mast of the first and second masts 111, 113. For example, the predetermined angle can be selected, without limitation, to be 30 degrees, 45 degrees, and the like.

In some non-limiting embodiments of the present technology, some of the cross-bars can be disposed at a first predetermined angle to the given mast of the first and second masts 111, 113 and some of the cross-bars can be disposed at a second predetermined angle to the given mast. For example, while the first predetermined angle can be selected 60 degrees, the second predetermined angle can be selected to be 120 degrees. In another example, the first and second predetermined angles of the given cross-bars to the given mast can be selected to be 45 and 135 degrees, respectively. It should be expressly understood that the cross-bars can be disposed between the first and second masts 111, 113 at more than two predetermined angles to the given mast; and in various non-limiting embodiments of the present technology, the plurality of cross-bars can be disposed between the first and second masts 111, 113 at a respective one of a plurality of predetermined angles, including, for example, 3, 4, 5, or even 10, different predetermined angles to the given mast of the first and second masts 111, 113 for disposing the cross-bars therebetween.

Further, it should be expressly understood that various arrangements of the transverse connecting section 115 are envisioned. For example, in some non-limiting embodiments of the present technology, the plurality of cross-bars of the transverse connecting section 115 disposed at different predetermined angles to the given mast of the first and second masts 111, 113 can define various periodically recurring patterns. For example, a given periodically recurring pattern can include a sequence of (i) a first cross-bar disposed at the first predetermined angle; (ii) a second cross-bar disposed perpendicularly; and (iii) a third cross-bar disposed at the second predetermined angle to the given mast of the first and second masts 111, 113 of the first vertically sliding section 112. Other predetermined periodically recurring patterns defining respective arrangements of the plurality of cross-bars in the transverse connecting section 115 are also envisioned without departing from the scope of the present technology.

As it can be appreciated, in some non-limiting embodiments of the present technology, the second vertically sliding section 112 can be implemented similarly to the first vertically sliding section 114.

Further, in some non-limiting embodiments of the present technology, to enable movement of the second vertically sliding section 114 against the first vertically sliding section 112, each one of the first and second masts 111, 113 of the first vertically sliding section 112 can include guides (not separately numbered) defined along each one of the first and second masts 111, 113; and each one of the masts (not separately numbered) of the second vertically sliding section 114 can include protrusions (not separately depicted) defined along each of the masts. The guides can be configured to receive or otherwise engage with protrusions, thereby enabling the second vertically sliding section 114 to slide against the first vertically sliding section 112. In other non-limiting embodiments of the present technology, the guides of the first and second masts 111, 113 of the first vertically sliding section 112 can be configured to receive masts of the second vertically sliding section 114. Thus, such configuration of the first and second vertically sliding sections 112, 114 allows for selective extension and retraction of the selectively extendable frame 110 to the desired length value.

A respective length of each of the first and second vertically sliding sections 112, 114 is not limited and depends generally on the desired maximum length value of the selectively extendable frame 110—that is, when it is fully extended. For example, in the desired maximum length of the selectively extendable frame 110 is four (4) meters, each one of the first and second vertically sliding sections 112, 114 can be around two-meter long. However, embodiments where each one of the first and second vertically sliding sections 112, 114 can have different respective length values, such as one and three meters, respectively, in the above example, are also envisioned. Also, it should be noted that for reaching the desired maximum length, the selectively extendable frame 110 can comprise more than two vertically sliding sections, such as three or five, for example, each given one of which can be configured to slide against a preceding one as described above with respect to the first and second vertically sliding sections 112, 114.

Further, to cause the second vertically extendable frame 114 to slide against the first vertically sliding section 106, thereby enabling the selectively extendable frame 110 to selectively extend or retract, according to certain non-limiting embodiments of the present technology, the inventory robot 100 can further comprise a frame actuator (not depicted), an actuator shaft of which is attached to the second vertically sliding section 114. Broadly speaking, the frame actuator can be configured to (i) cause the masts of the second vertically sliding section 114 to slide within the guides of the first vertically sliding section 112, thereby enabling the selective extension and retraction of the first and second vertically sliding sections 112, 114 relative to each other; (ii) and retain the second vertically sliding section 114 at the given level relative to the first vertically sliding section 112, thereby defining the desired length value of the selectively extendable frame 110.

In some non-limiting embodiments of the present technology, the frame actuator can be a rotation actuator configured to cause a linear movement of the second vertically sliding section 114 in the guides of the first vertically sliding section 112. In these embodiments, the frame actuator can be implemented similarly to the platform actuator described above.

However, in other non-limiting embodiments of the present technology, the frame actuator can be a linear actuator. Akin to the rotation actuator described above, in various non-limiting embodiments of the present technology, the linear actuator can be any type of actuator, including electric, pneumatic, and hydraulic, for example. In specific non-limiting example, the linear actuator can be one of the SGLF Series of servo linear electric actuators available from YASKAWA ELECTRIC CORPORATION of 2-1 Kurosakishiroishi, Yahatanishi-ku, Kitakyushu 806-0004 Japan. However, it should be noted that the servo linear electric actuator can be implemented using any other suitable equipment.

According to certain non-limiting embodiments of the present technology, akin to the platform actuator, the frame actuator can be communicatively coupled to the processor of the controller of the inventory robot 100; and the processor can be configured, based on respective control instructions, to cause the frame actuator to move the second vertically sliding section 114 relative to the first vertically sliding section 112, either upwards or downwards (in the orientation of FIG. 1), thereby causing the selectively extendable frame 110 to either extend or retract, respectively, to the desired length value.

It should be noted that in those embodiments where the selectively extendable frame 110 includes more than two vertically sliding sections, each one thereof, except for the first vertically sliding section 112, can be actuated by a separate frame actuator implemented similarly to the frame actuator described above.

However, it should be noted that manual actuation of the second vertically sliding section 114 relative to the first vertically sliding section 112 and retaining the former at the given level relative to the latter, for example, with pins receivable in respective holes defined in the masts of each one of the first and second vertically sliding sections 112, 114, is also envisioned without departing from the scope of the present technology.

In other non-limiting embodiments of the present technology, the selectively extendable frame 110 may be configured as a telescopic frame, such that the first and second sections 112, 114 are foldable. In further non-limiting embodiments, the selectively extendable frame 110 may more than two sections which are configured to fold onto one another. As previously described, actuation to extend and/or retract may be achieved via an electrical actuator or manual actuation of the selectively extendable frame 110.

Further, for monitoring the oscillations of the selectively extendable frame 110 during movement of the inventory robot 100, according to certain non-limiting embodiments of the present technology, the inventor robot 100 further comprises at least one oscillation sensor disposed at a position along the selectively extendable frame 110, for example the mast of at least one of the first and second vertically sliding sections 112, 114. The at least one oscillation sensor is configured to detect movement, such as oscillations, of the mast. In certain non-limiting embodiments of the present technology, the at least one oscillation sensor may be configured to detect a speed-parameter such as at least one of: a speed, an angular velocity, a linear velocity, a displacement from a then current position, an angular acceleration, and a linear acceleration of the mast. In some non-limiting embodiments of the present technology, the at least one oscillation sensor is a gyroscope to measure angular velocity. In some non-limiting embodiments of the present technology, the at least one oscillation sensor is an accelerometer to measure linear acceleration.

With continued reference to FIGS. 1 to 3, according to certain non-limiting embodiments of the present technology, each mast of the given first and second vertically sliding sections 112, 114 of the selectively extendable frame 110, such as the first and second masts 113, 115 of the first vertically sliding section 112 and/or second vertically sliding section 114, can accommodate the at least one oscillation sensor.

In some non-limiting embodiments of the present technology, the inventory robot 100 comprises a first oscillation sensor 202 disposed along the mast. More specifically, the first oscillation sensor 202 is positioned at a top portion 116 of the given mast of the second vertically sliding section 114 to detect oscillation of the top portion 116 of the given mast. For example, the mast may have a length of 12 m and the first oscillations sensor 202 may be positioned at the top of the 12 m mast.

In certain non-limiting embodiments of the present technology, the first oscillation sensor 202 is communicatively coupled to the processor of the inventory robot 100. As previously described, the first oscillation sensor 202 is configured to detect a speed-related parameter and send a first signal to the processor indicative of oscillations of the top portion 116 of the given mast. The processor is configured to receive the first signal thereby enabling real-time monitoring of oscillation of the mast and verifying if remedial action is required to prevent tilting or tipping of the inventory robot 100. The inventory robot 100 can tilt or tip as a result of resonance between the mast (and thereby the selectively extending frame 110) and the movable platform 102. In other words, during movement of the inventory robot 100, the frequency of oscillation of the mast may become close or equal to the frequency of the movable platform 102 such that the oscillation of the mast amplifies. This, in turn, produces larger oscillations of the mast, causing in tilting and, in worst cases, tipping of the inventory robot 100 which is a safety hazard for the workers and may cause damage to the warehouse shelving, the items, and/or the inventory robot 100 itself. As such, monitoring oscillations of the mast and providing remedial action when oscillations increase outside a threshold level can prevent tilt and tipping of the inventory robot 100.

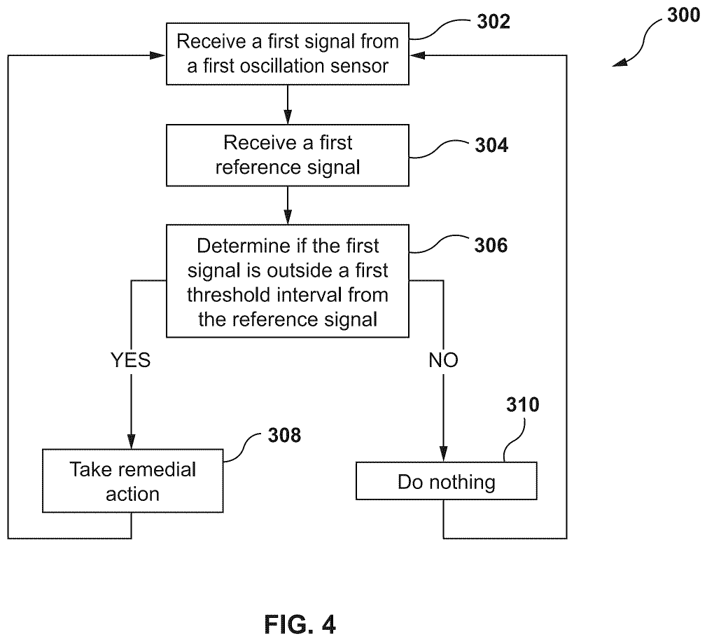

With reference to FIG. 4, there is depicted a method 300 for controlling the inventory robot 100. Broadly, according to certain non-limiting embodiments of the present technology, the method 300 includes receiving the first signal 302 from the first oscillation sensor 202, comparing the first signal 302 with a first reference signal 304, and determining if the first signal is outside a first threshold interval from the first reference signal 306. If the first signal is outside the first threshold interval, remedial action is taken 308 to avoid tilt or tipping of the robot 100. If the first signal is within the first threshold interval, no remedial action is required. In certain non-limiting embodiments of the present technology, the first reference signal is pre-determined and may be determined based on various parameters of the robot 100. Similarly, the first threshold interval is pre-determined and may be an absolute or a relative value. In certain non-limiting embodiments of the present technology, this process may be repeated to provide real-time control of the inventory robot 100.

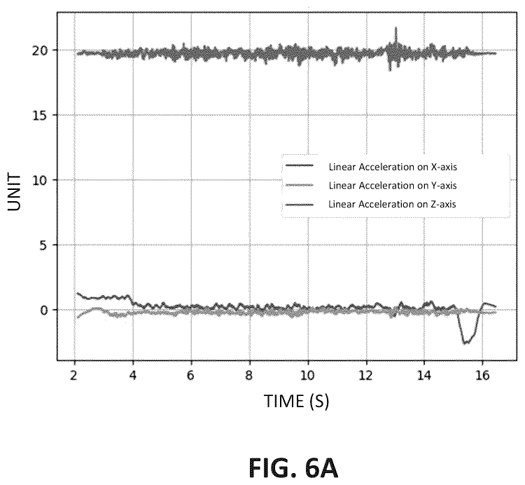

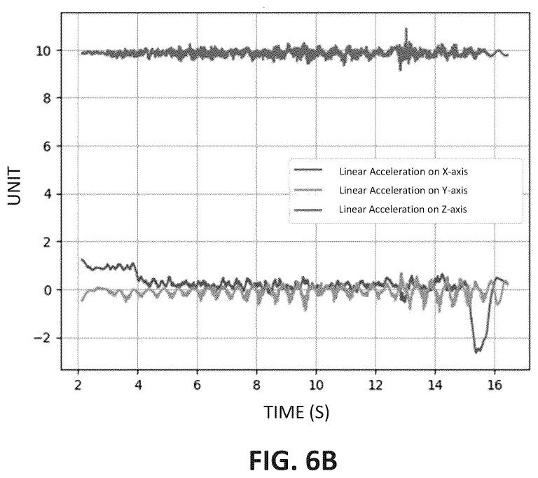

FIGS. 6A and 6B depict an exemplary signal from the first oscillation sensor 202 (that is, the first oscillation sensor 202 disposed at the top of the given mast). FIG. 6A depicts the linear acceleration of the given mast in the x, y, and z-axis in which oscillations are acceptable. FIG. 6B depicts the linear acceleration of the given mast in the x, y, and z-axis in which oscillations are outside the threshold interval and thus, considered high risk which results in remedial action being taken.

In some non-limiting embodiments of the present technology, remedial action is taken in response to the signal being outside the threshold interval to prevent the inventory robot 100 from tilting or tipping. As previously described, in certain non-limiting embodiments of the present technology, the processor of the inventory robot 100 is configured to control the motor (and thus, the speed) of the inventory robot 100. As such, the remedial action taken includes modifying a current speed of the inventory robot 100 to de-synchronize the frequency of the oscillation of the mast and the inventory robot 100. For example, in certain non-limiting embodiments of the present technology, the current speed of the inventory robot 100 is decreased. In other non-limiting embodiments of the present technology, the current speed of the inventory robot 100 may be increased. In further non-limiting embodiments of the present technology, the remedial action may include at least one of: adjusting the selectively extendable frame 110 height, adjusting or redistributing a container (or multiple containers) height along the selectively extendable frame 110, and sending an alert to notify warehouse personnel.

With reference to FIGS. 1 to 3, according to certain non-limiting embodiments of the present technology, the inventory robot 100 includes a second oscillation sensor 204 and a third oscillation sensor 206 disposed along the length of the given mast.

In certain non-limiting embodiments of the present technology, the second oscillation sensor 206 is positioned in between the top portion 116 and the bottom portion 118 of the given mast. That is to say, the second oscillation sensor 206 is positioned along a middle portion 120 of the mast. The second oscillation sensor 206 is communicatively coupled to the processor of the inventory robot 100. As previously described with regard to the first oscillation sensor 202, the second oscillation sensor 206 is configured to detect a speed-related parameter and send a second signal to the processor, configured to receive the second signal, indicative of oscillations of the middle portion 120 of the mast.

In some non-limiting embodiments of the present technology, the third oscillation sensor 204 is positioned at a bottom portion 118 of the given mast of the first vertically sliding section 112 to detect oscillation of the bottom portion 118 of the given mast. The third oscillation sensor 204 is communicatively coupled to the processor of the inventory robot 100. As previously described with regard to the first and second oscillation sensors 202, 206, the third oscillation sensor 204 is configured to detect a speed-related parameter and send a third signal to the processor, configured to receive the third signal, indicative of oscillations of the bottom portion 118 of the mast.

It is appreciated that, in other non-limiting embodiments of the present technology, each of the first, second, and second oscillation sensors 202, 206, 204 may be communicatively coupled to separate, respective, processors.

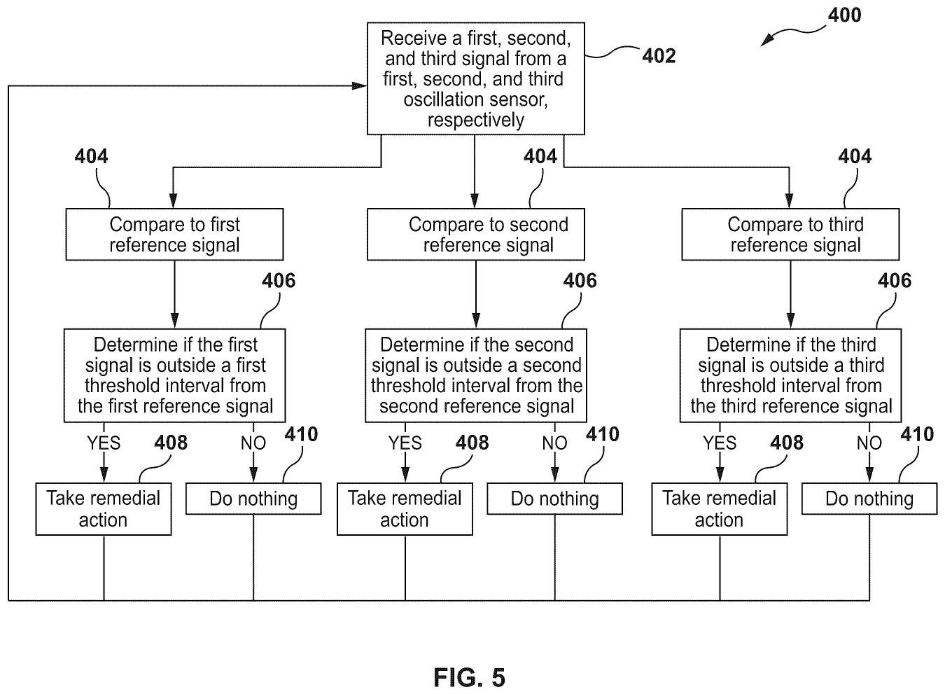

With reference to FIG. 5, according to non-limiting embodiments of the present technology, there is depicted a method 400 for controlling the inventory robot 100. Broadly, the method 400 includes receiving the first, second, and third signals 402 from each of the first, second, and second oscillation sensors 202, 206, 204 and comparing the respective signals with a first, second, and third reference signal 404. For each of the first, second, and third signals and respective reference signals, determine if each respective signal is outside of a respective threshold interval compared to the respective reference signal 406. In other words, the first signal is compared with the first reference signal to see if the first signal falls outside the first threshold interval, the second signal is compared with the second reference signal to see if the second signal falls outside the second threshold interval, and the third signal is compared with the third reference signal to see if the third signal falls outside the third threshold interval. If the respective signal falls outside the respective threshold interval, remedial action is taken 408. If the respective signal falls within the respective threshold interval, no remedial action is required 410. As previously described, in certain non-limiting embodiments of the present technology, the first, second, and third reference signals are pre-determined and may be based on various parameters of the robot 100. Similarly, the first, second, and third threshold intervals are pre-determined. The respective threshold intervals may be absolute values or may be relative values. In certain non-limiting embodiments of the present technology, this process may be repeated to provide real-time control of the inventory robot 100.

In certain non-limiting embodiments of the present technology, the method 400 includes receiving the first, second, and third signals 402 from each of the respective oscillation sensors 202, 206, 204. The first oscillation sensor 202 provides the first signal which is indicative of oscillations experienced by the top portion 116 of the mast. The second oscillation sensor 206 provides the second signal which is indicative of oscillations experienced by the middle portion 120 of the mast. The third oscillation sensor 204 provides the third signal which is indicative of oscillations experienced by the bottom portion 118 of the mast. In non-limiting embodiments of the present technology, the first, second, and third oscillation sensors 202, 206, 204 are evenly spaced along the length of the given mast. For example, if the given mast is 12 m in length, the first oscillation sensor 202 may be positioned at 12 m (the top of the given mast), second oscillation sensor 206 may be positioned at 6 m (the middle of the given mast), and third oscillation sensor 204 may be positioned at 0 m (the base of the given mast). In another non-limiting embodiments of the present technology, the first, second, and third oscillation sensors 202, 206, 204 may be evenly spaced apart from one another, such that the first oscillation sensor 202 is spaced apart from the second oscillation sensor 206 the same distance that the second oscillation sensor 206 is spaced apart from the third oscillation sensor 204.

In alternative non-limiting embodiments of the present technology, instead of multiple reference signals and threshold intervals, a single reference signal and a single threshold interval may used when comparing each of the respective signals generated by the oscillation sensors 202, 206, 204.

In certain non-limiting embodiments of the present technology, remedial action is taken in response to the first, second, and third signals falling outside the respective threshold interval from the respective reference signals. Similar to what has been previously described, the remedial action includes modifying the current speed of the inventory robot 100, for example decreasing the current speed of the inventory robot 100. In other non-limiting embodiments of the present technology, the current speed of the inventory robot 100 may be increased. In further non-limiting embodiments of the present technology, the remedial action may include at least one of: adjusting the selectively extendable frame 110 height, adjusting a container height along the selectively extendable frame 110, and sending an alert to notify warehouse personnel. As an example, in one embodiment, the second oscillation sensor 206 may provide the second signal indicative of an acceleration. In this example, the second threshold interval ranges between 0.5 m/s² and 2.0 m/s². If the second signal falls outside said second threshold interval, remedial action is taken. In another example, the second oscillation sensor 206 may provide the second signal indicative of an angular velocity. In this example, the second threshold interval ranges between 0.02 m/s² and 0.06 m/s². If the second signal falls outside said second threshold interval, remedial action is taken. In various non-limiting embodiments of the present technology, the first and third signals and respective threshold intervals may be implemented similarly to the second one. However, in some non-limiting embodiments of the present technology, the first, second, and third signals, as well as respective threshold intervals, do not have to be implemented the same way therebetween and those skilled in the art can select different values depending on the specific implementation.

In certain non-limiting embodiments, receiving of the respective signal, comparing the respective signal to the respective reference signal, and determining if the respective signal is outside the respective threshold may occur in parallel with one another (as depicted in FIG. 5). However, in other non-limiting embodiments of the present technology, it may occur in series. For example, the process may occur in order of risk level. That is, the process for oscillations in portions of the mast which pose the highest risk of tilt and tipping may occur first and the process for oscillations in portions of the mast which pose the lowest risk may occur last.

In some non-limiting embodiments of the present technology, the signals from the first, second, and third oscillation sensors 202, 206, 204 may be used to categorize the different types of oscillations being experienced by the mast and apply a “higher risk” threshold interval or a “lower risk” threshold interval. The respective signals may then be assessed if they fall outside of the higher-risk threshold interval and lower-risk threshold interval to determine if the respective remedial action is required.

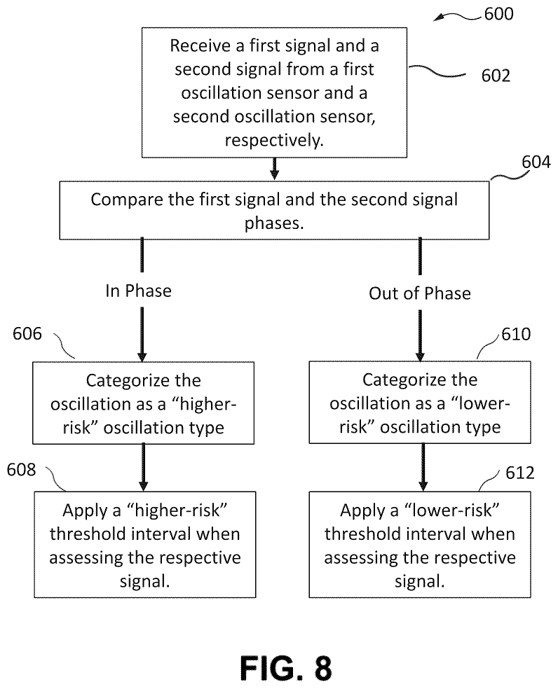

In some non-limiting embodiments of the present technology, the first signal and the second signal may be compared to determine if the signals are in phase with one another or out of phase with one another to categorize whether the oscillations are a higher-risk oscillation or a lower-risk oscillation (as depicted in FIG. 8). When signals are in phase with one another, their waveforms align at a given point in time. In other words, the peaks and troughs of the signals occur at the same time and overlap with one another. As a result, when the signals are added together, the amplitudes of the signals combine resulting in a larger signal and, ultimately, a larger, higher-risk oscillation. Conversely, when signals are out of phase, the waveforms of the signals are misaligned. As a result, when signals are added together, interference occurs leading to a weaker signal, and ultimately a weaker, lower-risk oscillation. The method 600 includes: receiving the first signal and the second signals 602 from the first oscillation sensor 202 and the second oscillation sensor 206, respectively; comparing the first signal with the second signal to determine if the first signal is in phase or out of phase with the second signal 604. If the signals are in phase with one another, categorizing the oscillation as a higher-risk oscillation type 606 and applying a higher-risk threshold interval 608. If the signals are out of phase with one another, categorizing the oscillation as a lower-risk oscillation type 610 and applying a lower-risk threshold interval 612.

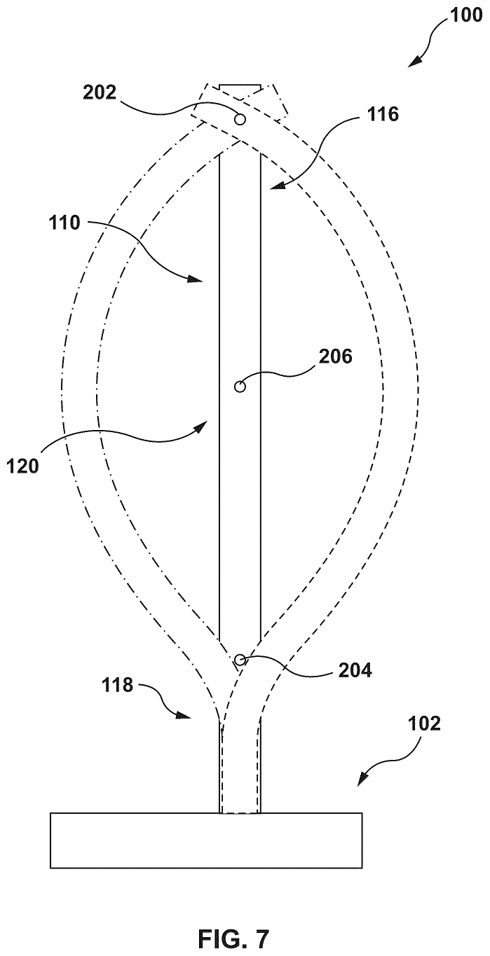

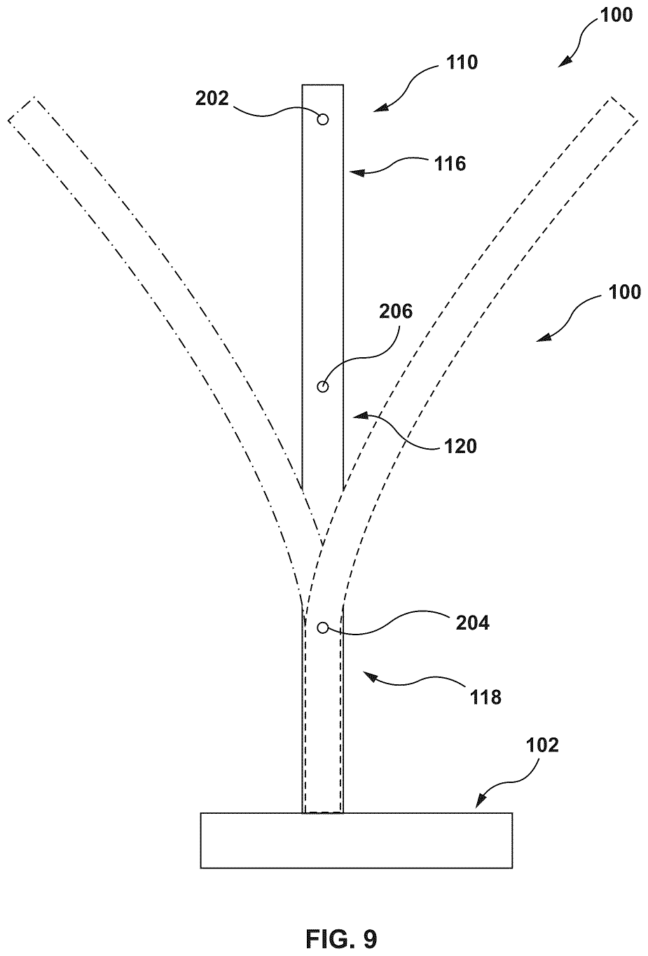

There is an increased risk in tilt and tipping when the oscillations occurring at the top portion 116 of the mast are larger than the oscillations at the bottom portion 118 of the mast (as depicted in FIG. 7). During this higher-risk oscillation type, the first signal, from the first oscillation sensor 202, and the second signal, from the second oscillation sensor 206, are in phase with one another. As a result, a higher-risk threshold value for the respective signals may be used. There is a lesser risk of tilt and tipping when oscillations occurring at the middle portion 120 of the mast are larger than oscillations at the top and bottom portions 116, 118 of the mast (as depicted in FIG. 9). During this lower-risk oscillation type, the first signal, from the first oscillation sensor 202, and the second signal, from the second oscillation sensor 206, are out of phase with one another. As a result, a lower-risk threshold value for the respective signals may be used. The lower-risk threshold values are different from the higher-risk threshold values. For example, the lower-risk threshold values may allow for higher tolerance than the higher-risk threshold values as the risk of tilt or tipping is less.

It should be expressly understood that any number of the previously described methods 300, 400, 600 for controlling the inventory robot 100 to avoid tilt may be implemented in any number of combinations.

In certain non-limiting embodiments of the present technology, each of the methods 300, 400, 600 for controlling said inventory robot 100 may run in parallel with one another.

In other non-limiting embodiments, the methods 300, 400, 600 may be implemented in series. In some non-limiting embodiments of the present technology, the methods 300, 400, 600 may be prioritized based on risk level. For example, having the top portion 116 of the mast oscillating outside of the threshold value poses a higher risk of tilt resulting in tipping and, thus, may be implemented as a first stage.

It is appreciated, in certain non-limiting embodiments of the present technology, that a machine learning algorithm may be implemented to control the inventory robot 100. The machine learning algorithm may be trained based on the inventory robot 100 testing data. The data collected during testing of the inventory robot 100 will be categorized as resulting in tilt and/or tipping (that is, “danger”) or not resulting in tilt and/or tipping (that is, “safe”). Specifically, the first signals from the first oscillation sensor 202, second signals from the second oscillation sensor 206 (if applicable), and third signals from the third oscillation sensor 204 (if applicable), are recorded and categorized as either being indicative of “danger” or “safe”.

In some embodiments of the present technology, testing data may include a plurality of training datasets comprising training inputs indicative of training signals, and labels indicative of whether the corresponding training signals are associated with a “danger” class or a “safe” class. It should be noted that plurality of training datasets may be grouped for respective speeds of operation of the inventory robot 100 without departing from the scope of the present technology. It is contemplated that the training input may further include a corresponding speed of the inventory robot 100 at which the inventory robot 100 has been operating when the corresponding training signal(s) has been captured by the sensor(s).

Broadly, machine learning algorithms can be used to process oscillation sensor signals in various applications, such as vibration analysis, structural health monitoring, and fault detection. These algorithms leverage the data generated by oscillation sensors to extract valuable insights and make informed decisions, such as signal classification, for example. In one embodiment, the machine learning algorithm may be a Neural Netowrk (NN) executed by the processor. A NN is a computational model consisting of interconnected nodes, or artificial neurons, organized into layers. These nodes work together to process and learn from data, making NNs a component of machine learning and deep learning techniques. In some embodiments, the machine learning algorithm may be implemented as a deep learning model such as a convolutional neural network (CNN) and recurrent neural network (RNN), for example, configured to process inter alia oscillation sensor data for classification purposes. CNNs are effective for feature extraction from sensor signals, while RNNs are useful for sequential data analysis.

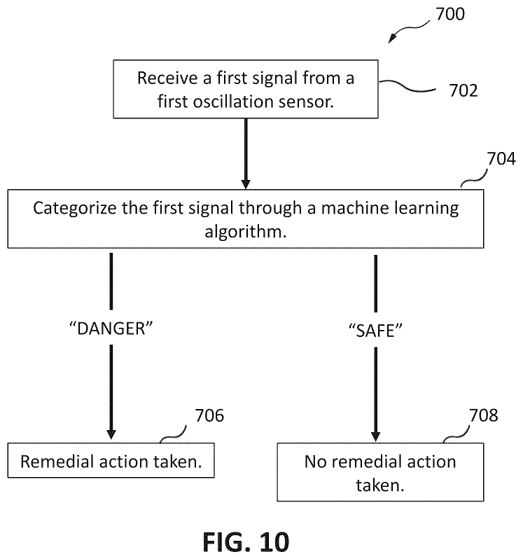

With reference to FIG. 10, a method 700 of controlling the inventory robot 100 with a first oscillation sensor 202 is depicted. The method 700 includes: receiving the first signal from the first oscillation sensor 702; and sending signal through the machine learning algorithm which categorizes the first signal as “danger” or “safe” 704. If categorized as “danger”, remedial action is taken 706. If categorized as “safe”, no remedial action is taken 708.

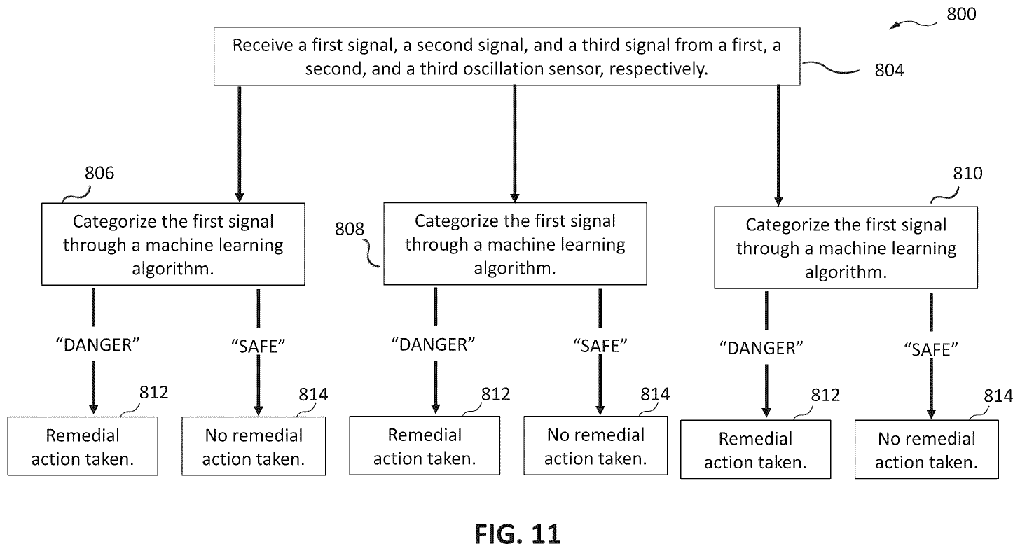

With reference to FIG. 11, a method 800 of controlling the inventory robot 100 with a first oscillation sensor 202, a second oscillation sensor 206, and a third oscillation sensor 204 is depicted. The method 800 includes: receiving the first signal from the first oscillation sensor, the second signal from the second oscillation sensor, and the third signal from the third oscillation sensor 804; and categorizing the respective signals through the machine learning algorithm 806, 808, 810. If categorized as “danger”, remedial action is taken 812. If categorized as “safe”, no remedial action is taken 814.

According to certain non-limiting embodiments of the present technology, any number of oscillation sensors may be positioned along the length of the given mast of the selectively extendable frame 110. In some non-limiting embodiments of the present technology, one oscillation sensor may be disposed on each section of the selectively extendable frame 110. For example, the selectively extendable frame 110 is configured to be a foldable frame having four sections configured to fold onto itself, an oscillation sensor may be positioned on each of the four sections to provide feedback for oscillations of each of these sections. Broadly, the inclusion of multiple oscillation sensors provides users with a more granular view on how the mast is oscillating during use.

Thus, certain non-limiting embodiments of the present technology may allow for a more effective monitoring of oscillations of the mast (and thereby selectively extendable frame 110) of the inventory robot 100. That is, through the use of at least one oscillation sensor positioned along the length of the mast, oscillations of the portion of the mast may be monitored. Further, some non-limiting embodiments of the present technology may allow for a more effective response to an increase in oscillations (i.e., when the oscillations of the mast resonate with the frequency of the moveable platform 102). Broadly, the signal generated by the at least one oscillation sensor is received by the processor and remedial action is taken if said signal is outside the threshold interval of acceptable oscillation range. Additionally, if a plurality of oscillation sensors is used, a more granular approach to monitoring oscillations and responding to higher risk oscillations may be achieved.

It should be noted, that although the inventory robot 100 has been described, the present technology may be applied to any robotic vehicle in which oscillations may cause tilt and tipping.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for controlling a robotic vehicle, the robotic vehicle including a ground platform movable on a ground surface, a longitudinal body extending from the ground platform, a sensor located along the longitudinal body, and a processor communicatively coupled to the sensor, the method comprising:
receiving a signal generated by the sensor indicative of oscillating movement of the longitudinal body during operation of the robotic vehicle on the ground surface;
receiving a reference signal representative of a normal operating state of the robotic vehicle;
in response to the signal being outside a threshold interval from the reference signal:
modifying a current speed of the robotic vehicle so as to reduce oscillating movement of the longitudinal body.

2. The method of claim 1, wherein modifying the current speed of the robotic vehicle comprises reducing the current speed of the robotic vehicle.

3. The method of claim 1, wherein:
the longitudinal body has a top end and a bottom end, the bottom end connected to the ground platform;
the sensor is a first sensor located at the top end of the longitudinal body, the signal being a first signal indicative of oscillating movement of the top end of the longitudinal body;
the robotic vehicle further comprising a second sensor located on a portion of the longitudinal body between the top end and the bottom end, the second sensor being communicatively coupled to the processor; and
the method comprising:
monitoring a second signal provided by the second sensor indicative of oscillating movement of the portion of the longitudinal body;
in response to the second signal being outside a second threshold interval from a second reference signal:
modifying the current speed of the robotic vehicle so as to reduce oscillating movement of the portion of the longitudinal body.

4. The method of claim 3, further comprising:
comparing the first signal of the first sensor and the second signal of the second sensor; and
determining whether the longitudinal body is experiencing a higher-risk oscillation type or a lower-risk oscillation type, wherein:
the higher-risk oscillation type occurs when the first signal and the second signal are in phase; and
the lower-risk oscillation type occurs when the first signal and the second signal are out of phase.

5. The method of claim 4, wherein:
when the higher-risk oscillation type is determined, the threshold interval is a first higher-risk threshold interval, and the second threshold interval is a second higher-risk threshold interval;
when the lower-risk oscillation type is determined, the threshold interval is a first lower-risk threshold interval, and the second threshold interval is a second lower-risk threshold interval;
the first lower-risk threshold interval is different than the first higher-risk threshold interval; and
the second lower-risk threshold interval is different than the second higher-risk threshold interval.

6. The method of claim 3, wherein:
the robotic vehicle further comprises a third sensor positioned on a bottom portion, the bottom portion located between the second sensor and the bottom end, the third sensor being communicatively coupled to the processor; and
the method further comprising:
monitoring a third signal provided by the third sensor indicative of oscillating movement of the bottom portion of the longitudinal body;
in response to the third signal being outside a threshold interval from a third reference signal:
modifying the current speed of the robotic vehicle so as to reduce oscillating movement of the bottom portion of the longitudinal body.

7. The method of claim 1, wherein receiving the signal generated by the sensor is indicative of at least one of: a speed, an angular velocity, a linear velocity, a displacement, an angular acceleration, and a linear acceleration of the longitudinal body.

8. The method of claim 1, further comprising redistributing a position of a container along a length of the longitudinal body, and sending an alert to an operator.

9. A robotic vehicle for delivering containers within a warehouse, the robotic vehicle comprising:
a ground platform moveable along a ground surface;
a longitudinal body extending from the ground platform for receiving and delivering a container;
a sensor positioned on the longitudinal body for generating a signal indicative of oscillating movement of the longitudinal body; and
at least one processor communicatively connected to the sensor, the at least one processor being configured to:
receive the signal generated by the sensor;
compare the signal with a reference signal; and
modify a current speed of the robotic vehicle if the signal is outside a threshold interval from the reference signal so as to reduce oscillating movement of the longitudinal body.

10. The robotic vehicle of claim 9, wherein:
the longitudinal body comprises a top end and a bottom end, the bottom end being connected to the ground platform; and
the sensor is a first sensor for generating a first signal positioned at the top end of the longitudinal body such that the first signal generated by the first sensor is indicative of oscillating movement of the top end of the longitudinal body.

11. The robotic vehicle of claim 10, further comprising:
a second sensor positioned at a portion of the longitudinal body for generating a second signal indicative of oscillating movement at the portion of the longitudinal body, the portion being between the top end and the bottom end of the longitudinal body; and
the at least one processor being communicatively connected to the second sensor, the at least one processor being configured to:
receive the second signal generated by the second sensor;
compare the second signal with a second reference signal; and
modify the current speed of the robotic vehicle if the second signal is outside a second threshold interval from the second reference signal so as to reduce oscillating movement of the portion.

12. The robotic vehicle of claim 11, wherein the first sensor and the second sensor are evenly spaced along the longitudinal body.

13. The robotic vehicle of claim 11, further comprising:
a third sensor positioned at a bottom portion of the longitudinal body for generating a third signal indicative of oscillating movement at the bottom portion of the longitudinal body, the bottom portion being between the bottom end and the second sensor; and
the at least one processor being communicatively connected to the third sensor, the at least one processor being configured to:
receive the third signal generated by the third sensor;
compare the third signal with a third reference signal; and
modify the current speed of the robotic vehicle if the third signal is outside a third threshold interval from the third reference signal so as to reduce oscillating movement of the bottom portion.

14. The robotic vehicle of claim 13, wherein the first sensor, the second sensor, and the third sensor, are evenly spaced along the longitudinal body.

15. The robotic vehicle of claim 9, wherein the longitudinal body is foldable and comprises a first body pivotably connected to a second body.

16. The robotic vehicle of claim 9, wherein a length of the longitudinal body is larger than a length of the ground platform.

17. A method for controlling a robotic vehicle, the robotic vehicle including a ground platform movable on a ground surface, a longitudinal body extending from the ground platform, a sensor located along the longitudinal body, and a processor communicatively coupled to the sensor, the method comprising:
receiving a signal generated by the sensor indicative of oscillating movement of the longitudinal body during operation of the robotic vehicle on the ground surface;
feeding the signal to a machine learning algorithm for determining a predicted class, the machine learning algorithm having been trained to predict whether the signal is of a first class or a second class based on a training signal and a label, the label being indicative of whether the training signal is of a first class or a second class; and
in response to the predicted class:
modifying a current speed of the robotic vehicle so as to reduce oscillating movement of the longitudinal body.
